(19) United States
(12) Patent Application Publication
(10) Pub. No.: US 2025/0037342 A1
(43) Pub. Date: Jan. 30, 2025

(54) VIRTUAL OBJECT INTERACTION

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/913,914

(22) Filed: Oct. 11, 2024

Related U.S. Application Data
(63) Continuation of application No. PCT/CN2023/118735, filed on Sep. 14, 2023.

(30) Foreign Application Priority Data
Oct. 18, 2022 (CN) 202211275400.4

(51) Int. Cl. G06T 13/40; G06T 17/00; G06V 10/25

(52) U.S. Cl. CPC G06T 13/40; G06T 17/00; G06V 10/25

(57) ABSTRACT

A virtual object interaction method is provided. In the method, a virtual scene including a first virtual object and a second virtual object is displayed. An interaction action selection interface with a plurality of candidate interaction actions based on a first operation being performed on the second virtual object is displayed. A target scene based on a second operation being performed on a target interaction action is displayed. The first virtual object and the second virtual object perform an interaction in the target scene based on the target interaction action.

### RELATED APPLICATIONS

The present application is a continuation of International Application No. PCT/CN2023/118735, filed on Sep. 14, 2023, which claims priority to Chinese Patent Application No. 202211275400.4, filed on Oct. 18, 2022. The entire disclosures of the prior applications are hereby incorporated by reference.

### FIELD OF THE TECHNOLOGY

This disclosure relates to the field of Internet technologies, including to a virtual object interaction method and apparatus, a device, and a computer-readable storage medium.

### BACKGROUND OF THE DISCLOSURE

With continuous development of Internet technologies, people have increasingly higher requirements for entertainment forms. For example, during game interaction, a user may perform interaction by controlling a virtual object in a virtual scene.

### SUMMARY

This disclosure provides a virtual object interaction method and apparatus, a device, and a non-transitory computer-readable storage medium. The technical solutions include but are not limited to the following aspects.

An aspect of this disclosure provides a virtual object interaction method. In the method, a virtual scene including a first virtual object and a second virtual object is displayed. An interaction action selection interface with a plurality of candidate interaction actions based on a first operation being performed on the second virtual object is displayed. A target scene based on a second operation being performed on a target interaction action is displayed. The first virtual object and the second virtual object perform an interaction in the target scene based on the target interaction action.

An aspect of this disclosure provides a virtual object interaction apparatus, the apparatus including processing circuitry configured to display a virtual scene includes a first virtual object and a second virtual object. The processing circuitry configured to display an interaction action selection interface with a plurality of candidate interaction actions based on a first operation being performed on the second virtual object. The processing circuitry configured to display a target scene based on a second operation being performed on a target interaction action in the plurality of candidate interaction actions. The first virtual object and the second virtual object perform an interaction in the target scene based on the target interaction action.

An aspect of this disclosure provides a computer device, including a processor and a memory, the memory having at least one program code stored therein, and the at least one program code being loaded and executed by the processor, to enable the computer device to implement any one of the virtual object interaction methods.

According to an aspect, a non-transitory computer-readable storage medium is further provided, having at least one program code stored therein, the at least one program code being loaded and executed by a processor, to enable a computer to implement any one of the virtual object interaction methods.

According to an aspect, a computer program or a computer program product is further provided, having at least one computer instruction stored therein, the at least one computer instruction being loaded and executed by a processor, to enable a computer to implement any one of the virtual object interaction methods.

In the examples provided in this disclosure, an interaction action selection page is displayed by dragging a second virtual object, to select a target interaction action from the interaction action selection page, so that a first virtual object and a second virtual object perform interaction based on the target interaction action. According to the method, positions of the first virtual object and the second virtual object in a virtual scene are more fully considered, thereby making an interaction process of the virtual object simpler, enhancing efficiency of interaction of the virtual object, and improving interaction flexibility, so that immersion of a user in virtual social interaction can be improved. In addition, because the interaction process of the virtual object is simpler, a quantity of user operations is reduced, to reduce a quantity of times that a terminal device responds based on the user operation, thereby reducing overheads of the terminal device.

### BRIEF DESCRIPTION OF THE DRAWINGS

FIG. 1 is a schematic diagram of an implementation environment of a virtual object interaction method according to an aspect of this disclosure.

FIG. 2 is a flowchart of a virtual object interaction method according to an aspect of this disclosure.

FIG. 3 is a schematic diagram of displaying a virtual scene according to an aspect of this disclosure.

FIG. 4 is a schematic diagram of displaying another virtual scene according to an aspect of this disclosure.

FIG. 5 is a schematic diagram of displaying another virtual scene according to an aspect of this disclosure.

FIG. 6 is a schematic diagram of a range bounding box of a dragged second virtual object according to an aspect of this disclosure.

FIG. 7 is a schematic diagram of another range bounding box of a dragged second virtual object according to an aspect of this disclosure.

FIG. 8 is a schematic diagram of displaying prompt information according to an aspect of this disclosure.

FIG. 9 is a schematic diagram of displaying a target object at a target position of a first virtual object according an aspect of this disclosure.

FIG. 10 is a schematic diagram of displaying an interaction action selection interface according to an aspect of this disclosure.

FIG. 11 is a schematic diagram of displaying a target scene according to an aspect of this disclosure.

FIG. 12 is a schematic diagram of displaying another target scene according to an aspect of this disclosure.

FIG. 13 is a schematic diagram of displaying a target scene according to an aspect of this disclosure.

FIG. 14 is a flowchart of a virtual object interaction method according to an aspect of this disclosure.

FIG. 15 is a schematic structural diagram of a virtual object interaction apparatus according to an aspect of this disclosure.

FIG. 16 is a schematic structural diagram of a terminal device according to an aspect of this disclosure.

FIG. 17 is a schematic structural diagram of a server according to an aspect of this disclosure.

### DETAILED DESCRIPTION

To make objectives, technical solutions, and advantages of this disclosure clearer, the following further describes in further detail examples of implementations of this disclosure with reference to the accompanying drawings.

Descriptions of terms involved in aspects of the disclosure are provided as examples only and are not intended to limit the scope of the disclosure.

Virtual social interaction: A user customizes a two-dimensional (2D) or three-dimensional (3D) virtual object (including but not limited to a humanoid model, a model of another form, or the like), and uses the virtual object of the user to perform a social chat with a virtual object of another person.

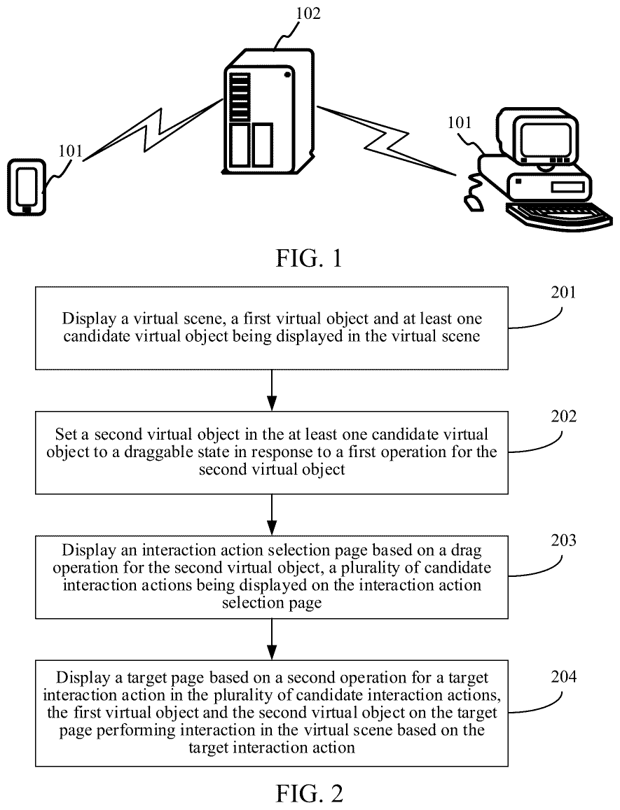

FIG. 1 is a schematic diagram of an implementation environment of a virtual object interaction method according to an embodiment of this disclosure. As shown in FIG. 1, the implementation environment includes: a terminal device 101 and a server 102.

The terminal device 101 may be at least one of a smartphone, a game host, a desktop computer, a tablet computer, an e-book reader, or a laptop portable computer. The terminal device 101 is configured to perform the virtual object interaction method provided in the embodiments of this disclosure.

The terminal device 101 may be one of a plurality of terminal devices. In this embodiment, the terminal device 101 is merely used as an example for description. A person skilled in the art may understand that there may be more or fewer terminal devices 101. For example, there may be only one terminal device 101, there may be dozens or hundreds of terminal devices 101, or there may be a greater quantity of terminal devices 101. A quantity of terminal devices and device types are not limited in the embodiments of this disclosure.

The server 102 is one server, a server cluster formed by a plurality of servers, or any one of a cloud computing platform and a virtualization center. This is not limited in the embodiments of this disclosure. The server 102 is in communication connection with the terminal device 101 through a wired network or a wireless network. The server 102 has a data receiving function, a data processing function, and a data transmission function. Certainly, the server 102 may also have other functions. This is not limited in the embodiments of this disclosure.

A person skilled in the art is to understand that the terminal device 101 and the server 102 are merely examples for description. Other terminal devices or servers, if applicable to this disclosure, are also to fall within the protection scope of this disclosure and are incorporated herein by reference.

An embodiment of this disclosure provides a virtual object interaction method, and the method is applicable to the implementation environment shown in FIG. 1. For example, FIG. 2 is a flowchart of a virtual object interaction method according to an embodiment of this disclosure. The method may be performed by the terminal device 101 in FIG. 1. As shown in FIG. 2, the method includes the following operations.

Operation 201: Display a virtual scene, a first virtual object and at least one candidate virtual object being displayed in the virtual scene.

In an example of this disclosure, an application capable of providing the virtual scene is installed and run in the terminal device. The application may be an application (also referred to as a host program) that needs to be downloaded and installed or may be an embedded program that depends on a host program to run, for example, an applet. This is not limited in the embodiments of this disclosure. The embedded program is an application that is developed based on a programming language and depends on the host program to run. The embedded program does not need to be downloaded and installed, and only needs to be dynamically loaded in the host program to run. A user may find an embedded program required by the user by searching, scanning, or the like, tap the embedded program required by the user in the host program to use the embedded program, and close the embedded program after use, so that internal memory of a terminal is not occupied, which is very convenient.

For example, based on an operation instruction for the application, the application is opened, and the virtual scene is displayed. The first virtual object and the at least one candidate virtual object are displayed in the virtual scene. In other words, the first virtual object and the at least one candidate virtual object are included in the virtual scene. A user corresponding to a candidate virtual object may be a friend user of a user corresponding to the first virtual object or may not be the friend user of the user corresponding to the first virtual object. The operation instruction for the application may be a tap operation for an icon of the application or may be another operation. This is not limited in the embodiments of this disclosure.

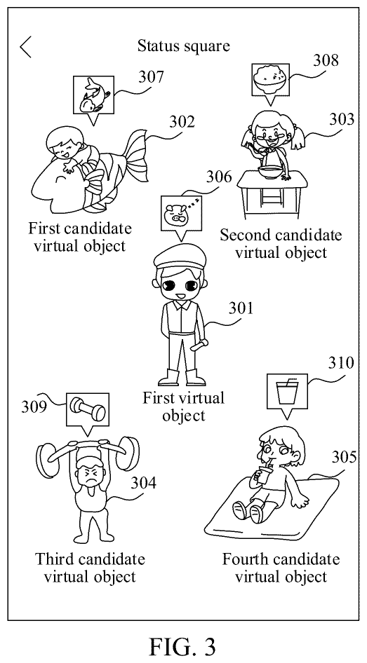

FIG. 3 is a schematic diagram of displaying a virtual scene according to an embodiment of this disclosure. A first virtual object 301, a first candidate virtual object 302, a second candidate virtual object 303, a third candidate virtual object 304, and a fourth candidate virtual object 305 are displayed in the virtual scene. The virtual scene may further include a scene identifier, for example, a “status square” shown in FIG. 3, and the scene identifier is configured for prompting that this is currently in the virtual scene.

The user may further zoom in or zoom out the virtual scene. When the virtual scene is zoomed in, an area of a virtual scene displayed in a display page of the terminal device is small, and a quantity of virtual objects displayed in the virtual scene is smaller; and when the virtual scene is zoomed out, the area of the virtual scene displayed in the display page of the terminal device is large, and the quantity of virtual objects displayed in the virtual scene is larger.

Operation 202: Set a second virtual object in the at least one candidate virtual object to a draggable state in response to a first operation for the second virtual object.

The terminal device may perform detection on the first operation, and when the first operation is detected and the first operation is for one or some candidate virtual objects in the at least one candidate virtual object, the terminal device uses one or more candidate virtual objects that the first operation is for as the second virtual object, so that a subsequent process of setting the second virtual object to the draggable state can be performed in response to the first operation for the second virtual object in the at least one candidate virtual object.

For example, the first operation for the second virtual object may be a long-press operation for the second virtual object. When the second virtual object is selected, and duration for which the second virtual object is selected exceeds a target duration, it is determined that the long-press operation for the second virtual object is received. In some embodiments, the target duration is set based on experience, or is adjusted based on an implementation environment. This is not limited in the embodiments of this disclosure. For example, the target duration is 1 second. Selecting the second virtual object may be an operation of tapping (tapping, double tapping, or another tapping manner) the second virtual object, or may be an operation of selecting the second virtual object by voice (for example, transmitting a voice message of “select X”, where X is a name of the second virtual object). A manner of selecting the second virtual object is not limited in the embodiments of this disclosure.

In an example, based on a received selection operation for the second virtual object, a first time when the selection operation for the second virtual object is received is determined, and a second time is determined based on the target duration and the first time (for example, a sum of the target duration and the first time is used as the second time). When the second virtual object is still in a selected state at the second time, it indicates that the first operation for the second virtual object in the at least one candidate virtual object is detected, and the second virtual object is set to the draggable state.

For example, if the selection operation for the second virtual object is received at 11:21:25 (that is, the first time), and the target duration is 1 second, the second time is at 11:21:26. When the second virtual object is still in the selected state at 11:21:26, the second virtual object is set to the draggable state.

In an example, action identifiers of actions currently performed by candidate virtual objects are further displayed (further included) in the virtual scene. For example, bubbles corresponding to the candidate virtual objects are displayed in the virtual scene, and the action identifiers of the actions currently performed by the virtual objects are displayed in the bubbles. The action identifier may be an image of the action, a name of the action, or another identifier capable of uniquely representing the action. This is not limited in the embodiments of this disclosure. In FIG. 3, 307 is a bubble corresponding to the first candidate virtual object, 308 is a bubble corresponding to the second candidate virtual object, 309 is a bubble corresponding to the third candidate virtual object, and 310 is a bubble corresponding to the fourth candidate virtual object.

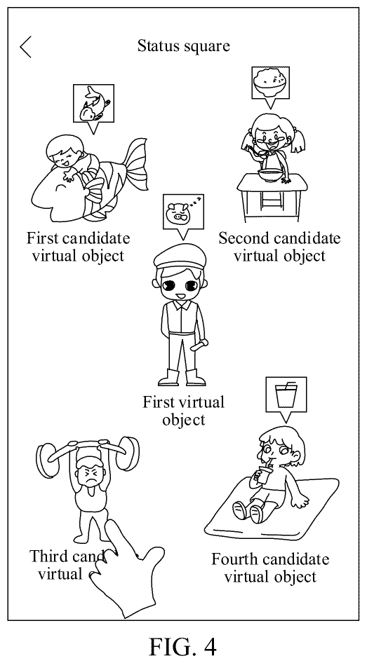

The method provided in this embodiment of this disclosure further includes: canceling displaying of an action identifier of an action currently performed by the second virtual object in response to the first operation for the second virtual object in the at least one candidate virtual object. FIG. 4 is a schematic diagram of displaying another virtual scene according to an embodiment of this disclosure. The third candidate virtual object is the second virtual object, and displaying of the bubble corresponding to the third candidate virtual object is canceled based on the first operation for the third candidate virtual object. In other words, displaying of an action identifier of an action currently performed by the third candidate virtual object is canceled.

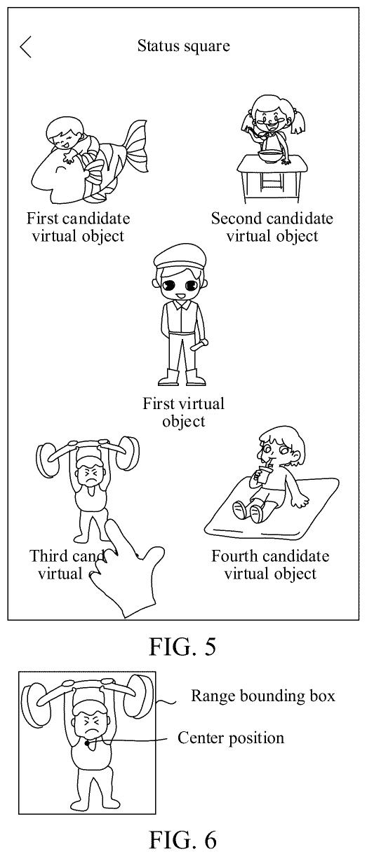

Alternatively, action identifiers of actions currently performed by candidate virtual objects are further displayed (further included) in the virtual scene. The method provided in this embodiment of this disclosure further includes: canceling displaying of the action identifiers of the actions currently performed by the candidate virtual objects in response to the first operation for the second virtual object in the at least one candidate virtual object. FIG. 5 is a schematic diagram of displaying another virtual scene according to an embodiment of this disclosure. The third candidate virtual object is the second virtual object, and the displaying of the action identifiers of the actions currently performed by the candidate virtual objects are canceled based on the first operation for the third candidate virtual object.

For example, operation 202 is an optional operation. In some implementations, after the virtual scene is displayed in operation 201, the at least one candidate virtual object included in the virtual scene is in a non-draggable state by default. In this case, operation 202 needs to be performed, to set the second virtual object to the draggable state based on the first operation, so that the user subsequently performs a drag operation for the second virtual object. Alternatively, in some other implementations, after the virtual scene is displayed in operation 201, the at least one candidate virtual object included in the virtual scene is in the draggable state by default. In this case, operation 202 does not need to be performed, so that the user may directly perform the drag operation for the second virtual object.

Operation 203: Display an interaction action selection page based on the drag operation for the second virtual object, a plurality of candidate interaction actions being displayed on the interaction action selection page.

The terminal device may perform detection on the drag operation, and when the drag operation is detected and the drag operation is for one or some candidate virtual objects in the at least one candidate virtual object, the terminal device uses one or more candidate virtual objects for the drag operation as the second virtual object, so that a subsequent process of displaying the interaction action selection page can be performed based on the drag operation for the second virtual object in the at least one candidate virtual object, the plurality of candidate interaction actions being included on the interaction action selection page.

When operation 202 needs to be performed before operation 203, the first operation in operation 202 and the drag operation in operation 203 are for a same second virtual object. In some implementations, the first operation and the drag operation are continuous operations, to be specific, an end moment of the first operation is the same as a start moment of the drag operation. In this case, after performing the first operation, the user may continuously perform the drag operation without releasing the hand. In some other implementations, the first operation and the drag operation are discontinuous operations, to be specific, an end moment of the first operation is earlier than a start moment of the drag operation. In this case, after performing the first operation, the user may first release the hand and then perform the drag operation.

In an example, a process of displaying the interaction action selection page based on the drag operation for the second virtual object includes: determining, based on the drag operation for the second virtual object, a range bounding box of the dragged second virtual object; and displaying the interaction action selection page based on that the range bounding box of the dragged second virtual object intersects with a range bounding box of the first virtual object. The range bounding box of the dragged second virtual object is configured for indicating an area covering the second virtual object, and the range bounding box of the first virtual object is configured for indicating an area covering the first virtual object.

A process of determining, based on the drag operation for the second virtual object, the range bounding box of the dragged second virtual object is not limited in the embodiments of this disclosure. For example, a center position of the dragged second virtual object is determined based on the drag operation for the second virtual object; a reference area is determined by using the center position of the dragged second virtual object as a center; and the reference area is used as the range bounding box of the dragged second virtual object.

In some embodiments, a rectangle is determined by using the center position of the dragged second virtual object as the center, a first length as a width, and a second length as a height, and an area corresponding to the rectangle is used as the reference area. The first length and the second length are set based on experience or are adjusted based on an implementation environment. This is not limited in the embodiments of this disclosure. FIG. 6 is a schematic diagram of the range bounding box of the dragged second virtual object according to an embodiment of this disclosure.

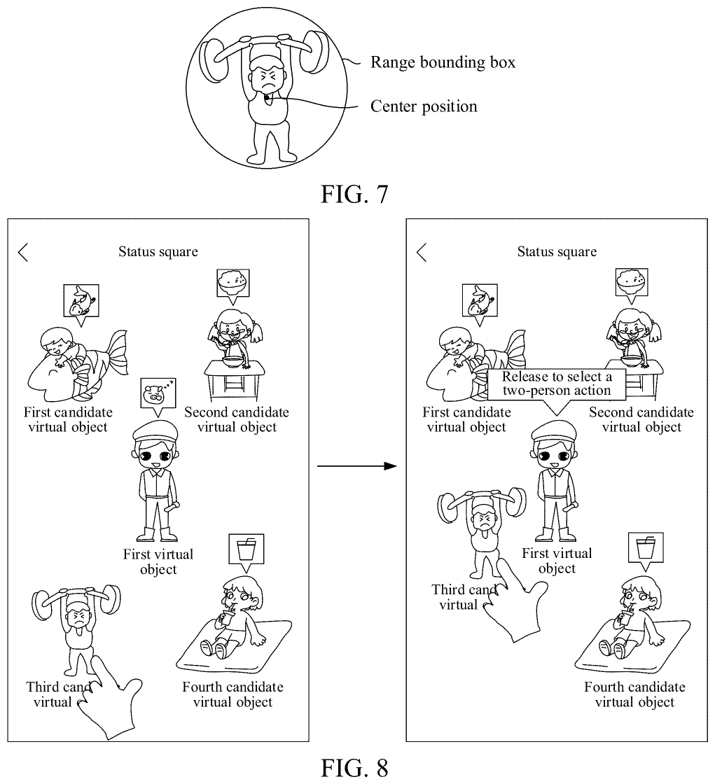

In some embodiments, a circle is determined by using the center position of the dragged second virtual object as the center and a third length as a radius, and an area corresponding to the circle is used as the reference area. The third length is set based on experience or is adjusted based on an implementation environment. This is not limited in the embodiments of this disclosure. FIG. 7 is a schematic diagram of another range bounding box of the dragged second virtual object according to an embodiment of this disclosure.

An example in which the reference area is the rectangle or the circle is described above for description. A shape of the reference area is not limited in the embodiments of this disclosure, and the shape of the reference area may alternatively be another possible shape, for example, a triangle. In addition, the range bounding box may have a plurality of forms. In addition to being in a transparent form (invisible to the user) shown in FIG. 6 and FIG. 7, the range bounding box may alternatively be in a non-transparent form (visible to the user), for example, a form filled with a shadow. A process of determining the range bounding box of the first virtual object is similar to the process of determining the range bounding box of the dragged second virtual object. Details are not described herein again.

In an example, an action identifier of an action currently performed by the first virtual object is further displayed (further included) in the virtual scene; and the method provided in this embodiment of this disclosure further includes: canceling displaying of the action identifier of the action currently performed by the first virtual object based on that the range bounding box of the dragged second virtual object intersects with the range bounding box of the first virtual object. For a manner of canceling displaying of the action identifier of the action currently performed by the first virtual object, refer to a manner of canceling displaying of the action identifier of the action currently performed by the second virtual object in FIG. 4. Details are not described herein again.

In an example, based on that the range bounding box of the dragged second virtual object intersects with the range bounding box of the first virtual object, there are the following two implementations to display the interaction action selection page.

Example 1: Display prompt information based on that the range bounding box of the dragged second virtual object intersects with the range bounding box of the first virtual object, the prompt information being configured for indicating to cancel dragging of the second virtual object; and display the interaction action selection page in response to canceling dragging of the second virtual object. Canceling dragging is also stopping dragging. The interaction action selection page is displayed in response to that the dragging of the second virtual object is stopped (to be specific, the terminal device detects that the drag operation is stopped). A position of the second virtual object before being dragged in the virtual scene is different from a position of the second virtual object after being stopped from being dragged in the virtual scene.

In some embodiments, the prompt information may be any content. This is not limited in the embodiments of this disclosure. For example, the prompt information is “release to select a two-person action”. FIG. 8 is a schematic diagram of displaying the prompt information according to an embodiment of this disclosure. Because the range bounding box of the dragged second virtual object intersects with the range bounding box of the first virtual object, the displaying of the action identifier of the action currently performed by the first virtual object is canceled, and the prompt information “release to select a two-person action” is displayed.

Example 2: Display a target object at a target position of the first virtual object based on that the range bounding box of the dragged second virtual object intersects with the range bounding box of the first virtual object, the target object being configured for indicating to cancel dragging of the second virtual object; and display the interaction action selection page in response to canceling dragging of the second virtual object. As described above, cancel dragging is also stopping dragging, and the interaction action selection page is displayed in response to that the dragging of the second virtual object is stopped (to be specific, the terminal device detects that the drag operation is stopped).

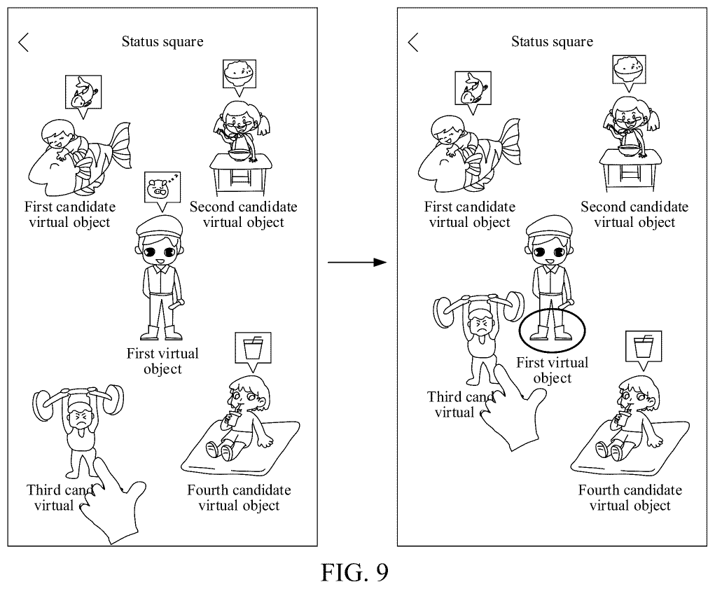

In some embodiments, the target position is any position, and the target object is any object. This is not limited in the embodiments of this disclosure. For example, the target position is at the foot of the first virtual object, and the target object is a circle. In other words, the circle is displayed at the foot of the first virtual object. FIG. 9 is a schematic diagram of displaying the target object at the target position of the first virtual object according to an embodiment of this disclosure. A form of the target object shown in FIG. 9 is merely an example and is not configured for limiting the form of the target object. The form of the target object may be set based on an actual requirement. For example, the form of the target object may alternatively be a form filled with a shadow.

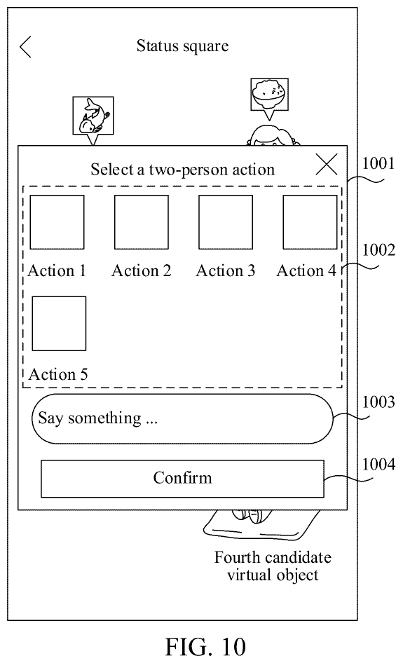

In an example, when the dragging of the second virtual object is canceled (or stopped), the interaction action selection page is displayed, at least one candidate interaction action is displayed on the interaction action selection page. FIG. 10 is a schematic diagram of displaying the interaction action selection page according to an embodiment of this disclosure. 1001 is the interaction action selection page, and 1002 is a plurality of candidate interaction actions. A page identifier may further be included on the interaction action selection page, and the page identifier is configured for prompting that this is currently on the interaction action selection page. For example, the page identifier is “select a two-person action” shown in FIG. 10.

Operation 204: Display a target page based on a second operation for a target interaction action in the plurality of candidate interaction actions, the first virtual object and the second virtual object on the target page performing interaction in the virtual scene based on the target interaction action.

The terminal device may perform detection on the second operation, and when the second operation is detected and the second operation is for one or some candidate interaction actions in the plurality of candidate interaction actions, the terminal device uses one or more candidate interaction actions that the second operation is for as the target interaction action, so that a subsequent process of displaying the target page can be performed based on the second operation for the target interaction action in the plurality of candidate interaction actions.

In an example, the target interaction action is any one of the plurality of candidate interaction actions. The second operation for the target interaction action is a selection operation for the target interaction action. For the selection operation, refer to descriptions in operation 202. Details are not described herein again.

In some embodiments, a process of displaying the target page based on the second operation for the target interaction action in the plurality of candidate interaction actions includes: generating an action data obtaining request based on the second operation for the target interaction action, the action data obtaining request including an action identifier of the target interaction action, an object identifier of the second virtual object, and an object identifier of the first virtual object; transmitting the action data obtaining request to a server, the action data obtaining request being configured for obtaining action data when the first virtual object and the second virtual object perform interaction based on the target interaction action; receiving the action data returned by the server based on the action data obtaining request; running the action data; and displaying the target page in response to that running of the action data is completed, the first virtual object and the second virtual object on the target page performing interaction in the virtual scene based on the target interaction action. In addition, for example, the second virtual object before being dragged and an action identifier of an action performed by the second virtual object before being dragged are still displayed on the target page.

The action identifier of the target interaction action may be an action name of the target interaction action or may be another identifier capable of uniquely representing the target interaction action. This is not limited in the embodiments of this disclosure. The object identifier of the virtual object may be a username of the user corresponding to the virtual object, an account of the user corresponding to the virtual object in the disclosure, or another identifier capable of uniquely representing the virtual object. This is not limited in the embodiments of this disclosure.

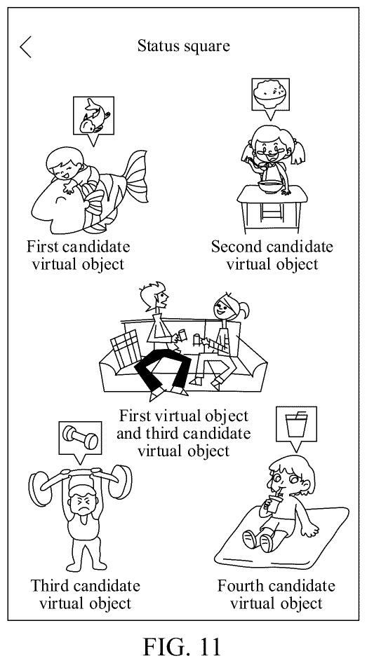

FIG. 11 is a schematic diagram of displaying a target page according to an embodiment of this disclosure. The second virtual object is the third candidate virtual object, the target interaction action is drinking coffee, and the first virtual object and the second virtual object are drinking coffee. The second virtual object before being dragged and the action identifier of the action performed by the second virtual object before being dragged are further displayed on the target page.

In some embodiments, a text input control is further displayed (included) on the interaction action selection page, and the text input control is configured to obtain text content, for example, 1003 in FIG. 10 is the text input control. A process of displaying the target page based on the second operation for the target interaction action in the plurality of candidate interaction actions includes: displaying the target page based on the second operation for the target interaction action in the plurality of candidate interaction actions and text content inputted in the text input control, the first virtual object and the second virtual object on the target page performing interaction in the virtual scene based on the target interaction action, and the text content being displayed (included) on the target page.

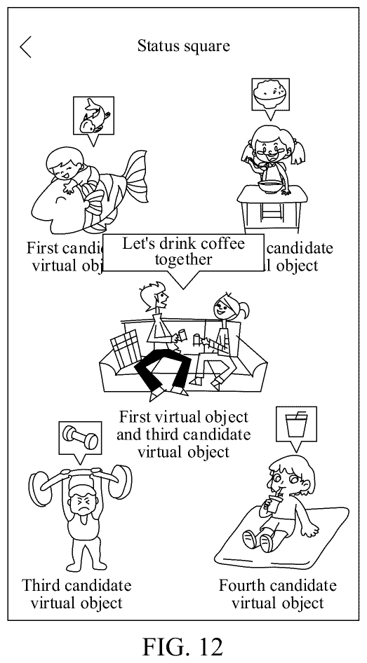

FIG. 12 is a schematic diagram of displaying another target page according to an embodiment of this disclosure. The second virtual object is the third candidate virtual object, the target interaction action is drinking coffee, the first virtual object and the second virtual object are drinking coffee in the virtual scene, and text content “let's drink coffee together” is displayed on the target page.

In some embodiments, a confirmation control, for example, 1004 in FIG. 10 is the confirmation control, is further displayed (included) on the interaction action selection page. A process of displaying the target page based on the second operation for the target interaction action in the plurality of candidate interaction actions includes: displaying the target page based on the second operation for the target interaction action in the plurality of candidate interaction actions and a third operation for the confirmation control. The third operation for the confirmation control may be a selection operation for the confirmation control, and timing of the third operation for the confirmation control is later than timing of the second operation for the target interaction action in the plurality of candidate interaction actions.

In some embodiments, when both the text input control and the confirmation control are included on the interaction action selection page, a process of displaying the target page based on the second operation for the target interaction action in the plurality of candidate interaction actions may include: displaying the target page based on the second operation for the target interaction action in the plurality of interaction actions, text content inputted in the text input control, and a third operation for the confirmation control. Timing of the third operation for the confirmation control is later than timing of the second operation for the target interaction action, and later than timing of inputting the text content in the text input control. The timing of the second operation for the target interaction action may be earlier than the timing of inputting the text content in the text input control or may be later than the timing of inputting the text content in the text input control. This is not limited in the embodiments of this disclosure.

In some embodiments, a process of displaying the target page based on the second operation for the target interaction action in the plurality of candidate interaction actions, the text content inputted in the text input control, and the third operation for the confirmation control includes: generating an action data obtaining request based on the second operation for the target interaction action in the plurality of candidate interaction actions, the text content inputted in the text input control, and the third operation for the confirmation control, the action data obtaining request including an action identifier of the target interaction action, an object identifier of the second virtual object, an object identifier of the first virtual object, and the text content; transmitting the action data obtaining request to a server; receiving the action data returned by the server based on the action data obtaining request; running the action data; and displaying the target page in response to that running of the action data is completed, the first virtual object and the second virtual object on the target page performing interaction in the virtual scene based on the target interaction action, and the text content being displayed on the target page.

In an example, a process of displaying the target page based on the second operation for the target interaction action in the plurality of candidate interaction actions includes: transmitting, based on the second operation for the target interaction action in the plurality of candidate interaction actions, an interaction message to a terminal device used by a user corresponding to the second virtual object, the interaction message including an action identifier of the target interaction action, and the interaction message being configured for indicating that the first virtual object and the second virtual object perform interaction in the virtual scene based on the target interaction action; and displaying the target page based on a received confirmation message transmitted by the terminal device used by the user corresponding to the second virtual object, the first virtual object and the second virtual object on the target page performing interaction in the virtual scene based on the target interaction action. In addition, for example, displaying of the second virtual object before being dragged on the target page may be canceled.

In some embodiments, a process of transmitting, based on the second operation for the target interaction action in the plurality of candidate interaction actions, the interaction message to the terminal device used by the user corresponding to the second virtual object includes: obtaining a friend list of a user corresponding to the first virtual object based on the second operation for the target interaction action in the plurality of candidate interaction actions; and transmitting, based on that the user corresponding to the second virtual object exists in the friend list of the user corresponding to the first virtual object, the interaction message to the terminal device used by the user corresponding to the second virtual object.

A process of determining whether the user corresponding to the second virtual object exists in the friend list of the user corresponding to the first virtual object includes: determining a user identifier of the user corresponding to the second virtual object; determining a user identifier of a user included in the friend list of the user corresponding to the first virtual object; and determining that the user corresponding to the second virtual object exists in the friend list of the user corresponding to the first virtual object if the user identifier of the user corresponding to the second virtual object exists in the user identifier of the user included in the friend list of the user corresponding to the first virtual object, or determining that the user corresponding to the second virtual object does not exist in the friend list of the user corresponding to the first virtual object if the user identifier of the user corresponding to the second virtual object does not exist in the user identifier of the user included in the friend list of the user corresponding to the first virtual object.

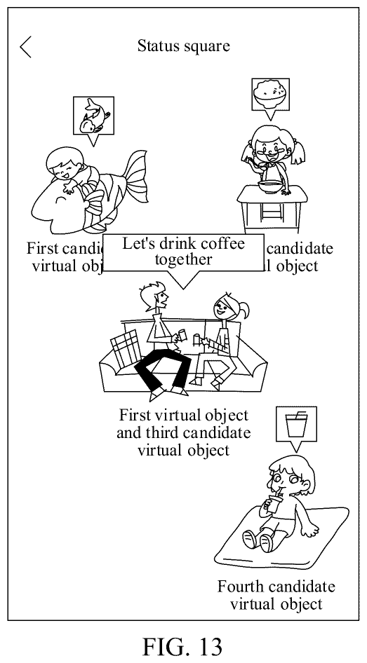

FIG. 13 is a schematic diagram of displaying a target page according to an embodiment of this disclosure. The second virtual object is the third candidate virtual object, the target interaction action is drinking coffee, and text content “let's drink coffee together” is further displayed on the target page. Displaying the third candidate virtual object before being dragged and displaying of the action identifier of the action performed by the third candidate virtual object before being dragged are both canceled.

In the foregoing method, an interaction action selection page is displayed by dragging a second virtual object, to select a target interaction action from the interaction action selection page, so that a first virtual object and a second virtual object perform interaction based on the target interaction action. According to the method, positions of the first virtual object and the second virtual object in a virtual scene are more fully considered, thereby making an interaction process of the virtual object simpler, enhancing efficiency of interaction of the virtual object, and improving interaction flexibility, so that immersion of a user in virtual social interaction can be improved. In addition, because the interaction process of the virtual object is simpler, a quantity of user operations is reduced, to reduce a quantity of times that a terminal device responds based on the user operation, thereby reducing overheads of the terminal device.

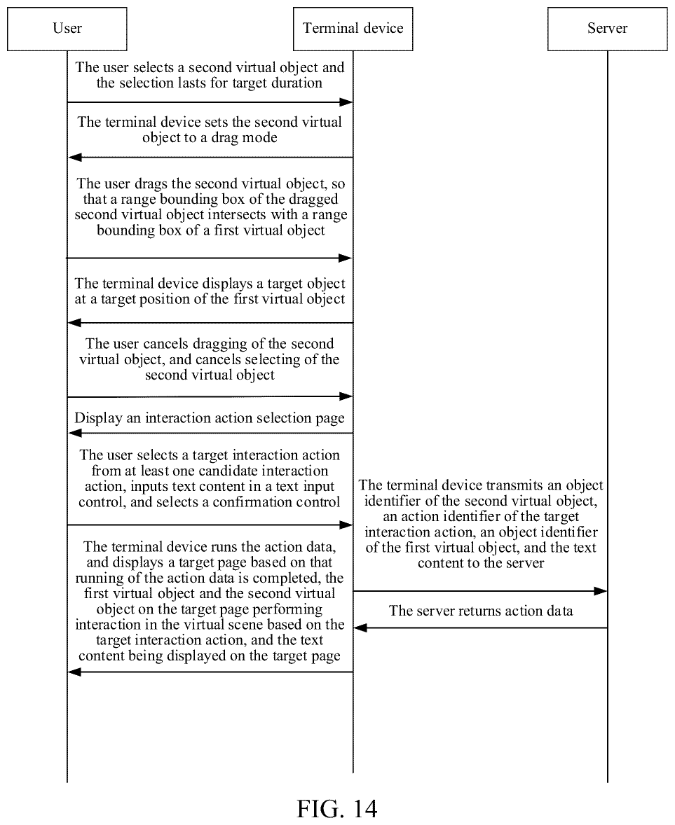

FIG. 14 is a flowchart of a virtual object interaction method according to an embodiment of this disclosure. Three execution entities are included, namely, a user, a terminal device, and a server.

The user selects a second virtual object and the selection lasts for target duration. The target duration is set based on experience, or is adjusted based on an implementation environment. This is not limited in the embodiments of this disclosure. For example, the target duration is 1 second.

The terminal device sets the second virtual object to a drag mode, so that the second virtual object can be moved to any position.

The user drags the second virtual object, so that a range bounding box of the dragged second virtual object intersects with a range bounding box of a first virtual object.

The terminal device displays a target object at a target position of the first virtual object. The target position may be any position, and the target object may be any object. This is not limited in the embodiments of this disclosure. For example, the target position is at the foot of the first virtual object, and the target object is a circle.

The user cancels dragging of the second virtual object, and cancels selecting of the second virtual object.

The terminal device displays an interaction action selection page, where at least one candidate interaction action, a text input control, and a confirmation control are displayed on the interaction action selection page. The text input control is configured to input text content by the user; and the text content may be any content. This is not limited in the embodiments of this disclosure.

The user selects a target interaction action from the at least one candidate interaction action, inputs the text content in the text input control, and selects the confirmation control. Timing of selecting the target interaction action and timing of inputting the text content in the text input control are earlier than timing of selecting the confirmation control, and the timing of selecting the target interaction action may be earlier than the timing of inputting the text content in the text input control, or may be later than the timing of inputting the text content in the text input control. This is not limited in the embodiments of this disclosure.

The terminal device transmits an object identifier of the second virtual object, an action identifier of the target interaction action, an object identifier of the first virtual object, and the text content to the server, so that the server obtains action data based on the object identifier of the second virtual object, the action identifier of the target interaction action, and the object identifier of the first virtual object, where the action data is action data when the first virtual object and the second virtual object perform interaction based on the target interaction action.

The server returns the action data.

The terminal device runs the action data, and displays a target page based on that running of the action data is completed, the first virtual object and the second virtual object on the target page performing interaction in the virtual scene based on the target interaction action, and the text content being displayed on the target page.

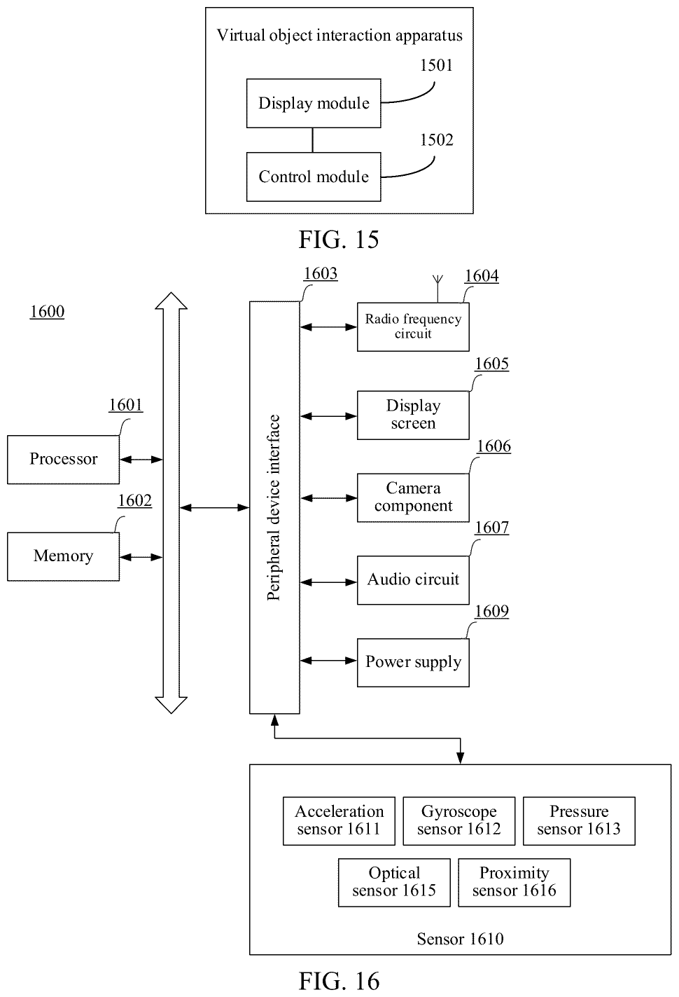

FIG. 15 is a schematic structural diagram of a virtual object interaction apparatus according to an embodiment of this disclosure. As shown in FIG. 15, the apparatus includes: a display module 1501 and a control module 1502.

The display module 1501 is configured to display a virtual scene, a first virtual object and at least one candidate virtual object being displayed (included) in the virtual scene.

The control module 1502 is configured to set, in response to a first operation for a second virtual object in the at least one candidate virtual object, the second virtual object to a draggable state.

The display module 1501 is further configured to display an interaction action selection page based on a drag operation for the second virtual object in the at least one candidate virtual object, a plurality of candidate interaction actions being displayed (included) on the interaction action selection page.

The display module 1501 is further configured to display a target page based on a second operation for a target interaction action in the plurality of candidate interaction actions, the first virtual object and the second virtual object on the target page performing interaction in the virtual scene based on the target interaction action.

For example, the control module 1502 is an optional module. In other words, the apparatus provided in this embodiment of this disclosure may only include the display module 1501. In some implementations, the apparatus may further include the control module 1502.

In an example, the apparatus further includes: a determining module, configured to determine, based on the drag operation for the second virtual object, a range bounding box of the dragged second virtual object, the range bounding box of the second virtual object being configured for indicating an area covering the second virtual object. An operation performed by the determining module may be completed by the display module 1501. In other words, the display module 1501 is configured to determine, based on the drag operation for the second virtual object, the range bounding box of the dragged second virtual object, the range bounding box of the second virtual object being configured for indicating the area covering the second virtual object.

The display module 1501 is configured to display the interaction action selection page based on that the range bounding box of the dragged second virtual object intersects with a range bounding box of the first virtual object.

In an example, the display module 1501 is configured to display prompt information based on that the range bounding box of the dragged second virtual object intersects with the range bounding box of the first virtual object, the prompt information being configured for indicating to cancel dragging (in other words, stop dragging) of the second virtual object; and display the interaction action selection page in response to canceling dragging of the second virtual object (in other words, the dragging of the second virtual object is stopped).

In an example, the display module 1501 is configured to display a target object at a target position of the first virtual object based on that the range bounding box of the dragged second virtual object intersects with the range bounding box of the first virtual object, the target object being configured for indicating to cancel dragging (in other words, stop dragging) of the second virtual object; and display the interaction action selection page in response to canceling dragging of the second virtual object (in other words, the dragging of the second virtual object is stopped).

In an example, the determining module is configured to determine, based on the drag operation for the second virtual object, a center position of the dragged second virtual object; determine a reference area by using the center position of the dragged second virtual object as a center; and use the reference area as the range bounding box of the dragged second virtual object.

An operation performed by the determining module may alternatively be completed by the display module 1501. In other words, the display module 1501 is configured to determine, based on the drag operation for the second virtual object, the center position of the dragged second virtual object; determine the reference area by using the center position of the dragged second virtual object as the center; and use the reference area as the range bounding box of the dragged second virtual object.

In an example, an action identifier of an action currently performed by the first virtual object is further displayed (further included) in the virtual scene; and the control module 1502 is further configured to cancel displaying of the action identifier of the action currently performed by the first virtual object based on that the range bounding box of the dragged second virtual object intersects with the range bounding box of the first virtual object.

In an example, action identifiers of actions currently performed by candidate virtual objects are further displayed (further included) in the virtual scene; and the control module 1502 is further configured to cancel displaying of an action identifier of an action currently performed by the second virtual object in response to the first operation for the second virtual object in the at least one candidate virtual object; or cancel displaying of the action identifiers of the actions currently performed by the candidate virtual objects in response to the first operation for the second virtual object in the at least one candidate virtual object.

In an example, a text input control is further displayed (included) on the interaction action selection page, and the text input control is configured to obtain text content; and the display module 1501 is configured to display the target page based on the second operation for the target interaction action in the plurality of candidate interaction actions and text content inputted in the text input control, the first virtual object and the second virtual object on the target page performing interaction in the virtual scene based on the target interaction action, and the text content being displayed (included) on the target page.

In an example, the apparatus further includes: a generation module, a transmission module, a receiving module, and a running module.

The generation module is configured to generate an action data obtaining request based on the second operation for the target interaction action in the plurality of candidate interaction actions, the action data obtaining request including an action identifier of the target interaction action, an object identifier of the second virtual object, and an object identifier of the first virtual object.

The transmission module is configured to transmit the action data obtaining request to a server, the action data obtaining request being configured for obtaining action data when the first virtual object and the second virtual object perform interaction based on the target interaction action.

The receiving module is configured to receive the action data returned by the server based on the action data obtaining request.

The running module is configured to run the action data.

The display module 1501 is configured to display the target page in response to that running of the action data is completed.

In addition, operations performed by the generation module, the transmission module, the receiving module, and the running module may alternatively be performed by the display module 1501. In other words, the display module 1501 is configured to generate the action data obtaining request based on the second operation for the target interaction action in the plurality of candidate interaction actions, the action data obtaining request including the action identifier of the target interaction action, the object identifier of the second virtual object, and the object identifier of the first virtual object; transmit the action data obtaining request to the server, the action data obtaining request being configured for obtaining the action data when the first virtual object and the second virtual object perform interaction based on the target interaction action; receive the action data returned by the server based on the action data obtaining request; run the action data; and display the target page in response to that running of the action data is completed.

In an example, the transmission module is configured to transmit, based on the second operation for the target interaction action in the plurality of candidate interaction actions, an interaction message to a terminal device used by a user corresponding to the second virtual object, the interaction message including an action identifier of the target interaction action, and the interaction message being configured for indicating that the first virtual object and the second virtual object perform interaction based on the target interaction action. An operation performed by the transmission module may be completed by the display module 1501. In other words, the display module 1501 is configured to transmit, based on the second operation for the target interaction action in the plurality of candidate interaction actions, the interaction message to the terminal device used by the user corresponding to the second virtual object, the interaction message including the action identifier of the target interaction action, and the interaction message being configured for indicating that the first virtual object and the second virtual object perform interaction based on the target interaction action.

The display module 1501 is configured to display the target page based on a confirmation message transmitted by the terminal device used by the user corresponding to the second virtual object.

In an example, the transmission module is configured to obtain a friend list of a user corresponding to the first virtual object based on the second operation for the target interaction action in the plurality of candidate interaction actions; and transmit, based on that the user corresponding to the second virtual object exists in the friend list of the user corresponding to the first virtual object, the interaction message to the terminal device used by the user corresponding to the second virtual object.

Operations performed by the transmission module may be completed by the display module 1501. In other words, the display module 1501 is configured to obtain the friend list of the user corresponding to the first virtual object based on the second operation for the target interaction action in the plurality of candidate interaction actions; and transmit, based on that the user corresponding to the second virtual object exists in the friend list of the user corresponding to the first virtual object, the interaction message to the terminal device used by the user corresponding to the second virtual object.

When the apparatus provided in the foregoing embodiment implements functions of the apparatus, division of the foregoing function modules is used as an example for description. For example, the functions may be allocated to and completed by different function modules based on requirements. To be specific, an internal structure of the device is divided into different function modules, to complete all or some of the functions described above. In addition, the apparatus provided in the foregoing embodiment and the method embodiments fall within a same conception. For details of a specific implementation process and generated technical effects of the apparatus, refer to the method embodiments. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 16 is a block diagram of a structure of a terminal device 1600 according to an exemplary embodiment of this disclosure. The terminal device 1600 may be a portable mobile terminal, such as a smartphone, a tablet computer, a moving picture experts group audio layer III (MP3) player, a moving picture experts group audio layer IV (MP4) player, a notebook computer, or a desktop computer. The terminal device 1600 may also be referred to as another name such as user equipment, a portable terminal, a laptop terminal, or a desktop terminal.

Generally, the terminal device 1600 includes: a processor 1601 and a memory 1602.

The processor 1601 may include one or more processing cores, such as a 4-core processor or an 8-core processor. Processing circuitry, such as the processor 1601 may be implemented in at least one hardware form of a digital signal processor (DSP), a field-programmable gate array (FPGA), and a programmable logic array (PLA). The processor 1601 may also include a main processor and a coprocessor. The main processor is a processor configured to process data in an awake state and is also referred to as a central processing unit (CPU). The coprocessor is a low power consumption processor configured to process data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602, such as a non-transitory computer-readable storage medium, may include one or more computer-readable storage media. The computer-readable storage medium may be non-transient (also referred to as non-transitory). The memory 1602 may further include a high-speed random access memory and a nonvolatile memory, such as one or more disk storage devices or flash storage devices. In some embodiments, the non-transient computer-readable storage medium in the memory 1602 is configured to store at least one instruction, the at least one instruction being configured to be executed by the processor 1601, to implement the virtual object interaction method provided in the method embodiments of this disclosure.

In some embodiments, the terminal device 1600 may further include: a peripheral device interface 1603 and at least one peripheral device. The processor 1601, the memory 1602, and the peripheral device interface 1603 may be connected through a bus or a signal cable. Each peripheral device may be connected to the peripheral device interface 1603 through a bus, a signal cable, or a circuit board. Specifically, the peripheral device includes: at least one of a radio frequency (RF) circuit 1604, a display screen 1605, a camera component 1606, an audio circuit 1607, and a power supply 1609.

The peripheral device interface 1603 may be configured to connect the at least one peripheral device related to input/output (I/O) to the processor 1601 and the memory 1602. In some embodiments, the processor 1601, the memory 1602 and the peripheral device interface 1603 are integrated on a same chip or circuit board. In some other embodiments, any one or two of the processor 1601, the memory 1602, and the peripheral device interface 1603 may be implemented on a single chip or circuit board. This is not limited in this embodiment.

The RF circuit 1604 is configured to receive and transmit a radio frequency (RF) signal, also referred to as an electromagnetic signal. The RF circuit 1604 communicates with a communication network and another communication device through the electromagnetic signal. The RF circuit 1604 converts an electric signal into an electromagnetic signal for transmission, or converts a received electromagnetic signal into an electric signal. In some embodiments, the RF circuit 1604 includes: an antenna system, an RF transceiver, one or more amplifiers, a tuner, an oscillator, a digital signal processor, a codec chip set, a subscriber identity module card, and the like. The RF circuit 1604 may communicate with another terminal device by using at least one wireless communication protocol. The wireless communication protocol includes but is not limited to: a world wide web, a metropolitan area network, an intranet, generations of mobile communication networks (2G, 3G, 4G, and 5G), a wireless local area network and/or a Wi-Fi network. In some embodiments, the RF circuit 1604 may further include a circuit related to near field communication (NFC). This is not limited in this disclosure.

The display screen 1605 is configured to display a user interface (UI). The UI may include a graph, a text, an icon, a video, and any combination thereof. When the display screen 1605 is a touch display screen, the display screen 1605 further has a capability of collecting a touch signal on or above a surface of the display screen 1605. The touch signal may be inputted to the processor 1601 as a control signal for processing. In this case, the display screen 1605 may be further configured to provide a virtual button and/or a virtual keyboard that are/is also referred to as a soft button and/or a soft keyboard. In some embodiments, there may be one display screen 1605, disposed on a front panel of the terminal device 1600. In some other embodiments, there may be at least two display screens 1605, respectively disposed on different surfaces of the terminal device 1600 or designed in a foldable shape. In still some other embodiments, the display screen 1605 may be a flexible display screen, disposed on a curved surface or a folded surface of the terminal device 1600. Even, the display screen 1605 may be further set in a non-rectangular irregular pattern, namely, a special-shaped screen. The display screen 1605 may be prepared by using a material such as a liquid crystal display (LCD) or an organic light-emitting diode (OLED).

The camera component 1606 is configured to collect an image or a video. In some embodiments, the camera component 1606 includes a front camera and a rear camera. Generally, the front camera is disposed on the front panel of the terminal device 1600, and the rear camera is disposed on a back surface of the terminal device 1600. In some embodiments, there are at least two rear cameras, which are any of a main camera, a depth-of-field camera, a wide-angle camera, and a telephoto camera, to implement a background blurring function through fusion of the main camera and the depth-of-field camera, a panoramic photographing function and a virtual reality (VR) photographing function through fusion of the main camera and the wide-angle camera, or other fusion photographing functions. In some embodiments, the camera component 1606 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1607 may include a microphone and a speaker. The microphone is configured to collect sound waves of a user and an environment, and convert the sound wave into an electrical signal to input to the processor 1601 for processing, or input to the RF circuit 1604 for implementing voice communication. For the purpose of stereo collection or noise reduction, there may be a plurality of microphones, respectively disposed at different parts of the terminal device 1600. The microphone may further be an array microphone or an omni-directional collection type microphone. The speaker is configured to convert an electric signal from the processor 1601 or the RF circuit 1604 into a sound wave. The speaker may be a conventional thin-film speaker, or may be a piezoelectric ceramic speaker. When the speaker is a piezoelectric ceramic speaker, the speaker can convert an electric signal into an acoustic wave audible to a human being, and also can convert an electric signal into an acoustic wave inaudible to a human being, for ranging and other purposes. In some embodiments, the audio circuit 1607 may further include an earphone jack.

The power supply 1609 is configured to supply power to components in the terminal device 1600. The power supply 1609 may be an alternating current, a direct current, a primary battery, or a rechargeable battery. When the power supply 1609 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal device 1600 further includes one or more sensors 1610. The one or more sensors 1610 include, but are not limited to: an acceleration sensor 1611, a gyroscope sensor 1612, a pressure sensor 1613, an optical sensor 1615, and a proximity sensor 1616.

The acceleration sensor 1611 may detect a magnitude of acceleration on three coordinate axes of a coordinate system established with the terminal device 1600. For example, the acceleration sensor 1611 may be configured to detect components of gravity acceleration on the three coordinate axes. The processor 1601 may control, based on a gravity acceleration signal collected by the acceleration sensor 1611, the display screen 1605 to display the UI in a landscape view or a portrait view. The acceleration sensor 1611 may be further configured to collect motion data of a game or a user.

The gyroscope sensor 1612 may detect a body direction and a rotation angle of the terminal device 1600. The gyroscope sensor 1612 may cooperate with the acceleration sensor 1611 to collect a 3D action by the user on the terminal device 1600. The processor 1601 may implement the following functions based on data collected by the gyroscope sensor 1612: motion sensing (for example, changing the UI based on a tilt operation by the user), image stabilization at shooting, game control, and inertial navigation.

The pressure sensor 1613 may be disposed at a side frame of the terminal device 1600 and/or a lower layer of the display screen 1605. When the pressure sensor 1613 is disposed at the side frame of the terminal device 1600, a holding signal of the user on the terminal device 1600 may be detected. The processor 1601 performs left and right hand recognition or a quick operation based on the holding signal collected by the pressure sensor 1613. When the pressure sensor 1613 is disposed on the low layer of the display screen 1605, the processor 1601 controls an operable control on the UI based on a pressure operation by the user for the display screen 1605. The operable control includes at least one of a button control, a scroll-bar control, an icon control, and a menu control.

The optical sensor 1615 is configured to collect ambient light intensity. In an embodiment, the processor 1601 may control display brightness of the display screen 1605 based on the ambient light intensity collected by the optical sensor 1615. Specifically, when the ambient light intensity is high, display brightness of the display screen 1605 is increased. When the ambient light intensity is low, display brightness of the touch display screen 1605 is decreased. In another embodiment, the processor 1601 may further dynamically adjust a camera parameter of the camera component 1606 based on the ambient light intensity collected by the optical sensor 1615.

The proximity sensor 1616, also referred to as a distance sensor, is generally disposed on the front panel of the terminal device 1600. The proximity sensor 1616 is configured to collect a distance between a user and a front surface of the terminal device 1600. In an embodiment, when the proximity sensor 1616 detects that the distance between the user and the front surface of the terminal device 1600 gradually becomes small, the display screen 1605 is controlled by the processor 1601 to switch from a screen-on state to a screen-off state. When the proximity sensor 1616 detects that the distance between the user and the front surface of the terminal device 1600 gradually becomes large, the display screen 1605 is controlled by the processor 1601 to switch from the screen-off state to the screen-on state.

A person skilled in the art may understand that the structure shown in FIG. 16 constitutes no limitation on the terminal device 1600, and the terminal device may include more or fewer components than those shown in the figure, or some components may be combined, or a different component arrangement may be used.

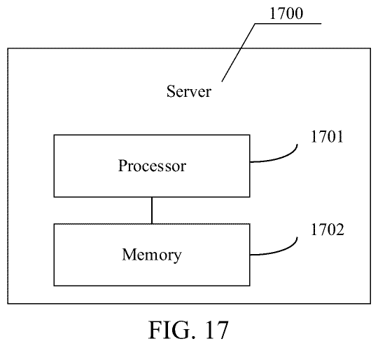

FIG. 17 is a schematic structural diagram of a server 1700 according to an embodiment of this disclosure. The server 1700 may vary due to different configurations or performance, and may include one or more central processing units (CPUs) 1701 and one or more memories 1702. The one or more memories 1702 have at least one program code stored therein, the at least one program code being loaded and executed by the one or more CPUs 1701, to implement the virtual object interaction method provided in the foregoing method embodiments. Certainly, the server 1700 may further include components such as a wired or wireless network interface, a keyboard, and an input/output (I/O) interface, to facilitate input and output. The server 1700 may further include another component configured to implement a function of a device. Details are not described herein again.

In an exemplary embodiment, a non-transitory computer-readable storage medium is further provided, having at least one program code stored therein, the at least one program code being loaded and executed by a processor, to enable a computer to implement any one of the foregoing virtual object interaction methods.

In some embodiments, the non-transitory computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided, having at least one computer instruction stored therein, the at least one computer instruction being loaded and executed by a processor, to enable a computer to implement any one of the foregoing virtual object interaction method.

“Plurality of” described in this specification refers to two or more. “And/or” describes an association relationship of associated objects, indicating that three relationships may exist. For example, A and/or B may indicate the following three cases: Only A exists, both A and B exist, and only B exists. The character “/” generally represents an “or” relationship between the associated objects. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Sequence numbers of the foregoing embodiments of this disclosure are merely for illustrative purposes, and are not intended to indicate priorities of the embodiments.

The foregoing descriptions are merely examples of embodiments of this disclosure, and are not intended to limit this disclosure. Any modification, equivalent replacement, or improvement made within the principle of this disclosure shall fall within the protection scope of this disclosure.

What is claimed is:

1. A virtual object interaction method, the method comprising:
displaying, by processing circuitry, a virtual scene including a first virtual object and a second virtual object;
displaying an interaction action selection interface with a plurality of candidate interaction actions based on a first operation being performed on the second virtual object; and
displaying a target scene based on a second operation being performed on a target interaction action in the plurality of candidate interaction actions, wherein the first virtual object and the second virtual object perform an interaction in the target scene based on the target interaction action.

2. The method according to claim 1, wherein the displaying the interaction action selection interface comprises:
displaying the interaction action selection interface when a range bounding box of the second virtual object intersects with a range bounding box of the first virtual object, wherein the range bounding box of the second virtual object is configured for indicating an area covering the second virtual object according to the first operation.

3. The method according to claim 2, wherein the displaying the interaction action selection interface comprises:
displaying prompt information when the range bounding box of the second virtual object intersects with the range bounding box of the first virtual object, the prompt information being configured to indicate the first operation of the second virtual object is to be stopped; and
displaying the interaction action selection interface in response to the first operation of the second virtual object being stopped.

4. The method according to claim 2, wherein the displaying the interaction action selection interface comprises:
displaying, at a target position of the first virtual object, a target object when the range bounding box of the second virtual object intersects with the range bounding box of the first virtual object, the target object indicating the first operation of the second virtual object is to be stopped; and
displaying of the interaction action selection interface in response to the first operation of the second virtual object being stopped.

5. The method according to claim 2, wherein
the first operation is a drag operation; and
the method further comprises:
determining, based on the drag operation being performed on the second virtual object, a center position of the dragged second virtual object;
determining a reference area by using the dragged second virtual object as a center; and
using the reference area as the range bounding box of the dragged second virtual object.

6. The method according to claim 5, further comprising:
canceling display of an action identifier of an action currently performed by the first virtual object in the virtual scene when the range bounding box of the dragged second virtual object intersects with the range bounding box of the first virtual object.

7. The method according to claim 5, further comprising:
canceling display of an action identifier of an action currently performed by the second virtual object in response to a third operation being performed on the second virtual object; or
canceling display of action identifiers of actions currently performed by a plurality of candidate virtual objects in response to the third operation being performed on the second virtual object.

8. The method according to claim 1, wherein the interaction action selection interface includes a text input interface, and the method further comprises:
displaying the target scene based on the second operation being performed on the target interaction action in the plurality of candidate interaction actions and text input in the text input interface, the inputted text being displayed in the target scene.

9. The method according to claim 1, wherein the displaying the target scene comprises:
generating a request for obtaining action data based on the second operation, the request including an action identifier of the target interaction action, an object identifier of the second virtual object, and an object identifier of the first virtual object;
transmitting the request to a server to obtain the action data for the first virtual object and the second virtual object to perform interaction based on the target interaction action;
processing the action data returned by the server based on the request; and
displaying the target scene when the processing of the action data is completed.

10. The method according to claim 1, wherein the displaying the target scene comprises:
transmitting, based on the second operation, an interaction message to a user device corresponding to the second virtual object, the interaction message including an action identifier of the target interaction action of the first virtual object and the second virtual object; and
displaying the target scene based on a confirmation message that is received from the user device corresponding to the second virtual object.

11. The method according to claim 10, wherein the transmitting comprises:
obtaining a friend list of a user corresponding to the first virtual object based on the second operation; and
transmitting, based on a user corresponding to the second virtual object in the friend list of the user corresponding to the first virtual object, the interaction message to the user device corresponding to the second virtual object.

12. A virtual object interaction apparatus, the apparatus comprising:
processing circuitry configured to:
display a virtual scene includes a first virtual object and a second virtual object;
display an interaction action selection interface with a plurality of candidate interaction actions based on a first operation being performed on the second virtual object; and
display a target scene based on a second operation being performed on a target interface action in the plurality of candidate interaction actions, wherein the first virtual object and the second virtual object perform an interaction in the target scene based on the target interaction action.

13. The apparatus according to claim 12, wherein the display the interaction action selection interface the processing circuitry configured to:
display the interaction action selection interface when a range bounding box of the second virtual object intersects with a range bounding box of the first virtual object, wherein the range bounding box of the second virtual object is configured for indicating an area covering the second virtual object according to the first operation.

14. The apparatus according to claim 13, wherein the processing circuitry configured to:
display prompt information when the range bounding box of the second virtual object intersects with the range bounding box of the first virtual object, the prompt information is configured to indicates the first operation of the second virtual object is to be stopped; and
display the interaction action selection interface in response to the first operation of the second virtual object being stopped.

15. The apparatus according to claim 12, wherein the processing circuitry configured to:
generate a request for obtaining action data based on the second operation, the request including an action identifier of the target interaction action, an object identifier of the second virtual object, and an object identifier of the first virtual object;
transmit the request to a server to obtain the action data for the first virtual object and the second virtual object perform interaction based on the target interaction action;
process the action data returned by the server based on the request; and
display the target scene when the process of the action data is completed.

16. The apparatus according to claim 12, wherein the processing circuitry configured to:
transmit, based on the second operation, an interaction message to a user device corresponding to the second virtual object, the interaction message includes an action identifier of the target interaction action of the first virtual object and the second virtual object; and
display the target scene based on a confirmation message is received from the user device corresponding to the second virtual object.

17. A non-transitory computer-readable storage medium, storing instructions which when executed by a processor cause the processor to perform:
displaying a virtual scene including a first virtual object and a second virtual object;
displaying an interaction action selection interface with a plurality of candidate interaction actions based on a first operation being performed on the second virtual object; and
displaying a target scene based on a second operation being performed on a target interaction action in the plurality of candidate interaction actions, wherein the first virtual object and the second virtual object perform an interaction in the target scene based on the target interaction action.

18. The non-transitory computer-readable storage medium according to claim 17, wherein the instructions when executed by the processor further cause the processor to perform:
displaying the interaction action selection interface when a range bounding box of the second virtual object intersects with a range bounding box of the first virtual object, wherein the range bounding box of the second virtual object is configured for indicating an area covering the second virtual object according to the first operation.

19. The non-transitory computer-readable storage medium according to claim 17, wherein the instructions when executed by the processor further cause the processor to perform:
generating a request for obtaining action data based on the second operation, the request including an action identifier of the target interaction action, an object identifier of the second virtual object, and an object identifier of the first virtual object;
transmitting the request to obtain the action data for the first virtual object and the second virtual object perform interaction based on the target interaction action;
processing the action data returned by the request; and
displaying the target scene when the processing of the action data is completed.

20. The non-transitory computer-readable storage medium according to claim 17, wherein the instructions when executed by the processor further cause the processor to perform:
transmitting, based on the second operation, an interaction message to a user device corresponding to the second virtual object, the interaction message including an action identifier of the target interaction action of the first virtual object and the second virtual object; and
displaying the target scene based on a confirmation message that is received from the user device corresponding to the second virtual object.
